(19) United States
(12) Patent Application Publication
(10) Pub. No.: US 2025/0112220 A1
(43) Pub. Date: Apr. 3, 2025

(54) METHOD OF, AND APPARTUS FOR, ANNEALING THE EXPOSED METAL EDGE MARGIN OF A BATTERY ELECTRODE

(71) Applicant: GM GLOBAL TECHNOLOGY OPERATIONS LLC, Detroit, MI (US)

(72) Inventors: Raghavendra Saikrishna Keerthi MANDA, Northville, MI (US); Daniel Gerardo GONZALEZ, Lake Orion, MI (US); Jeffery Thomas WHITE, JR., Chesterfield, MI (US); Srilakshim KATAR, Troy, MI (US); Subrahmanyam GORIPARTI, Troy, MI (US); Liang XI, Northville, MI (US)

(21) Appl. No.: 18/477,108

(22) Filed: Sep. 28, 2023

(51) Int. Cl. H01M 4/04

(52) U.S. Cl. CPC H01M 4/0471

(57) ABSTRACT

A method of annealing an exposed metal edge margin of a coated battery electrode strip to relieve stress and reduce wrinkling includes applying a magnetic field through an apertured magnetic shield to the exposed metal edge margins. The magnetic field induces eddy currents that heat the exposed metal edge margins to an annealing temperature, while the magnetic shield blocks the magnetic field near the near the coating to protect it from overheating. An apparatus for annealing an exposed metal edge margin of a coated battery electrode strip includes a source of magnetic field and an apertured magnetic shield. In an alternative embodiment, the apparatus includes a laser is for heating the exposed metal edge margin without overheating the coating.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

This disclosure relates to the manufacture of battery electrodes, and in particular to methods of, and apparatus for, annealing the exposed metal edges of battery electrodes.

A common practice in the manufacturing of battery electrodes is to anneal the uncoated edges of the electrode strip before calendaring the electrode coating. This annealing can remove residual stresses and/or help prevent the edges from wrinkling. Typical annealing temperatures are between 20° and 300° C. A problem with currently available annealing technology is the possibility of unintentional heating of the coated section of the electrode, which could have a negative effect on battery cell performance. This is particularly true where the melting point of the binder used for the coating is less than the annealing temperature, which is often the case.

### SUMMARY

Generally, embodiments of this disclosure provide methods for annealing the exposed edge margins of electrode strips after they have been coated with electrode material, and preferably after those coatings have been calendered.

According to a first embodiment of this disclosure, a magnetic field is applied through an apertured magnetic shield to the exposed metal edge margins of the coated battery electrode strip to induce eddy currents in the metal edge margins to heat the exposed metal edge margins to a desired annealing temperature range. The apertured shield blocks the application of the magnetic field close enough to edge of the coating material to exceed a temperature deleterious to the coating on the electrode strip. The electrode strip is preferably moved past the magnetic field source and apertured shield, and the source and shield are spaced and positioned so that the heating of the exposed edge margin does not overly heat the coating material on the substrate.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side elevation view showing an electromagnet applying a magnetic field to the exposed metal edge margin of a battery electrode;

FIG. 2 is a top plan view of the battery electrode strip showing the exposed metal edge margin, and one of the layers of calendared electrode material;

FIG. 3 is a side elevation view showing an electromagnet applying a magnetic field through a shield to the exposed metal edge margin of a battery electrode;

FIG. 4 is a top plan view of the battery electrode strip showing the exposed metal edge margin with the area of application of the magnetic field, and one of the layers of calendared electrode material;

FIG. 5A is a top plan view of a magnetic shield with a circular aperture;

FIG. 5B is a top plan view of a magnetic shield with a semi-circular or “D” shaped aperture;

FIG. 5C is a top plan view of a magnetic shield with a rectangular aperture;

FIG. 5D is a top plan view of a magnetic shield with a trapezoidal aperture, wider at one side than the other;

FIG. 6 is a side elevation view showing an electromagnet applying a magnetic field through a shield to the top surface and to the bottom surface of the exposed metal edge margin of a battery electrode;

FIG. 7A is a magnified view of the electrode material applied to the surfaces of the battery electrode;

FIG. 7B is a magnified view of the electrode material applied to the surfaces of the battery electrode after exposure to a substrate temperature of 220° C.;

FIG. 7C is a magnified view of the electrode material applied to the surfaces of the battery electrode after exposure to a substrate temperature of 300° C.; and

FIG. 8 is schematic view of an alternate embodiment of this disclosure.

In the drawings, reference numbers may be reused to identify similar and/or identical elements.

### DETAILED DESCRIPTION

Embodiments of this disclosure provide methods for annealing the exposed edge margins of battery electrode strips after they have been coated with electrode material, and preferably before those coatings have been calendered.

During the process of battery manufacturing, electrodes are prepared by coating metal strip substrates. Typically, copper foil is used for the negative electrode for the anode and aluminum is used for the positive electrode for the cathode (because aluminum oxidizes more readily than copper). The substrates, typically in the form of a continuous metal strip, are coated with anode and cathode materials on one or both sides, respectively, and the coated substrates are calendered to reduce the porosity of the electrode which generally improves the particle contact and thus enhances the energy density of the battery. Calendering can also impact the pore structure and thus also the wettability of the electrodes. Finally, calendaring can help assure a uniform coating on the electrodes.

The electrode coatings are typically not applied all the way to the edge of the substrate, leaving an exposed metallic edge margin. In some processes it is common to anneal these exposed metallic edge margins to relieve stresses in the material, and to help reduce wrinkling of these metallic edge margins.

According to a first embodiment of this disclosure, a magnetic field is applied through an apertured magnetic shield to the exposed metal edge margins of the coated battery electrode strip to induce eddy currents in the metal edge margins to heat the exposed metal edge margins to a desired annealing temperature (typically in the range of 200-300° C.). The apertured shield blocks the application of the magnetic field close enough to edge of the coating material on the substrate, heat the substrate in the vicinity of the coating to a temperature deleterious to the coating material. For example, some binders commonly used in battery electrodes have a melting point at 165° C., and when these binders are used it could be deleterious to the electrode material to exceed this temperature.

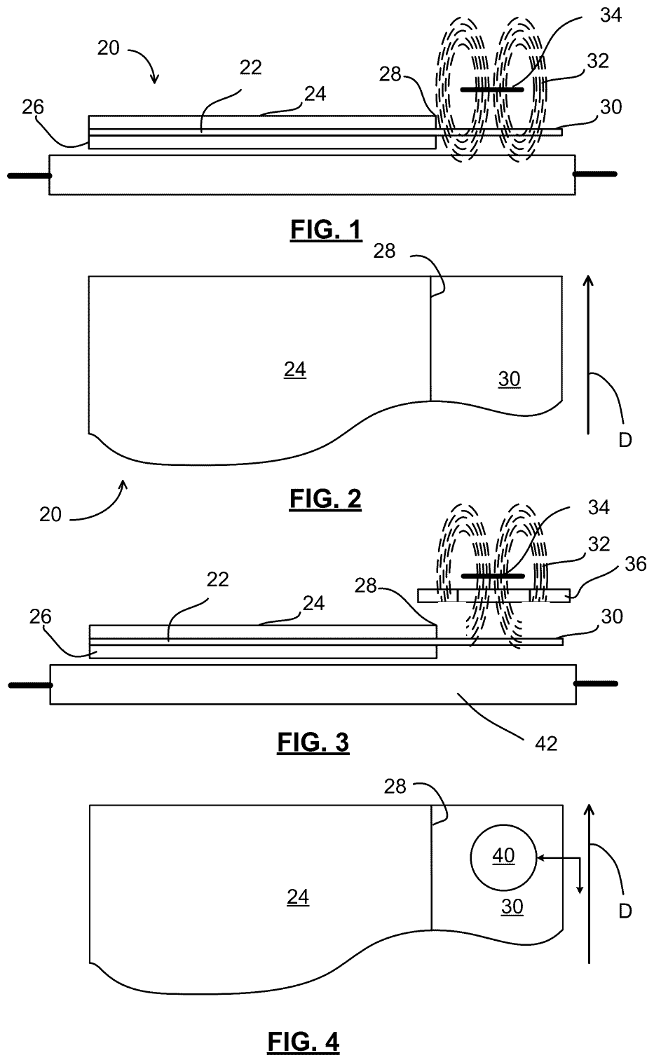

As shown in FIGS. 1-2, an electrode strip 20 comprises a continuous metal strip substrate 22 (usually copper of aluminum), coated with a layer of electrode material 24 and 26 on each face. As is common, the coating does not extend all the way to the edge of the substrate 22, but terminates at edge 28, leaving an exposed metal edge margin 30. It is common to anneal this exposed metal edge margin 30 after the layers of electrode material have been calendered, to remove residual stress and reduce wrinkling of the exposed metal edge margin.

As also shown in FIG. 1, a magnetic field 32 can be applied to the exposed metal edge margin 30 of the electrode strip 20. This magnetic field 32 can be applied, for example with an electromagnetic coil 34. The magnetic field 32 induces eddy currents in the exposed metal edge margin 30, which heat the exposed metal edge margin. This inductive heating can heat the exposed metal edge margin 30 to a desired annealing temperature (typically 200-300° C.). However, this heating can also reach the edge 28 of the layers 24 and 26 of electrode material on the substrate 22, and potentially adversely affect the electrode material.

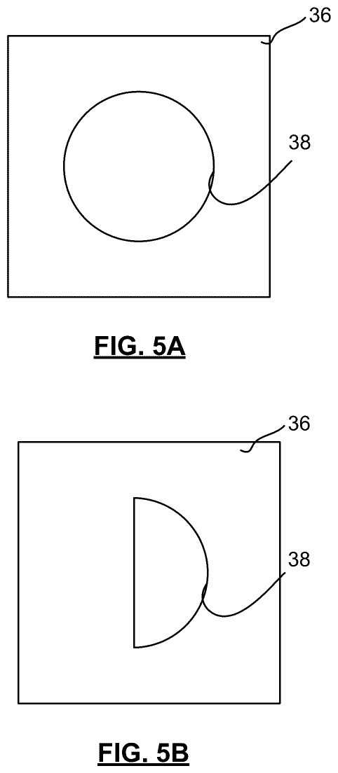

As shown in FIGS. 3 and 4, according to the principles of this disclosure, a magnetic shield 36 having an aperture 38 can be interposed between the source of the magnetic field and the exposed metal edge margin 30 of the electrode strip 20, to control the location 40 where the magnetic field 32 induces heating in the edge margin. By spacing the location 40 sufficiently from the edges 28, and controlling the time of application, the temperature adjacent to the layers 24 and 26 can be maintained below a temperature that adversely affects the material in the layers.

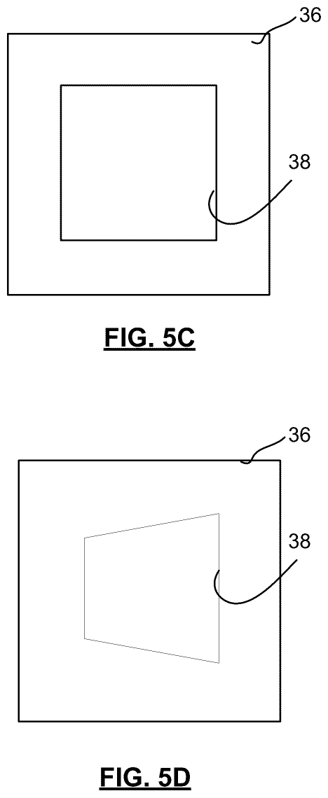

As shown in FIGS. 5A-5D, the shield 36 has at least one aperture 38 to pass the magnetic flux (represented by magnetic field lines 32). This aperture 38 can have a shape control the amount and location of the application of the magnetic field to the exposed metal edge margin 30. As shown in FIG. 5A, the aperture 38 can be circular. As shown in FIG. 5B, the aperture 38 can have a semicircular or “D” shape, with a straight side that can be oriented parallel to the edge 28. As shown in FIG. 5C, the aperture 38 can have a rectangular shape (square as shown), with a straight side that can be oriented parallel to the edge 28. As shown in FIG. 5D, the aperture 38 can have a trapezoidal shape, with a straight side that can be oriented parallel to the edge 28, and which widens toward the edge of the exposed metal edge margin 30, so that relatively more energy is delivered to the substrate 22 nearer the edge of the exposed metal edge margin, and relatively less energy is delivered to the substrate adjacent the edges 28.

The size and the shape of the aperture 38 can be designed to deliver the energy to the exposed metal edge margin to achieve a desired temperature profile. This shape will depend on the nature of the magnetic field being applied, the internal resistance and heat conductivity of the substrate material, and the duration of exposure. In embodiments where the electrode material moves relative to the magnetic field source and shield, the speed of movement is also a factor.

The shield 36 can be made of one or more magnetic shielding materials, including at least one of copper, silver, brass, ferromagnetic alloys, steel, stainless steel, permalloy, mu metal, aluminum, titanium, tungsten, and lead or any non-ferromagnetic material. The shield can comprise a plurality of layers of material, either layers of the same material or layers of different material. At least some of the shield material can be in the form of a mesh or a metallic foam.

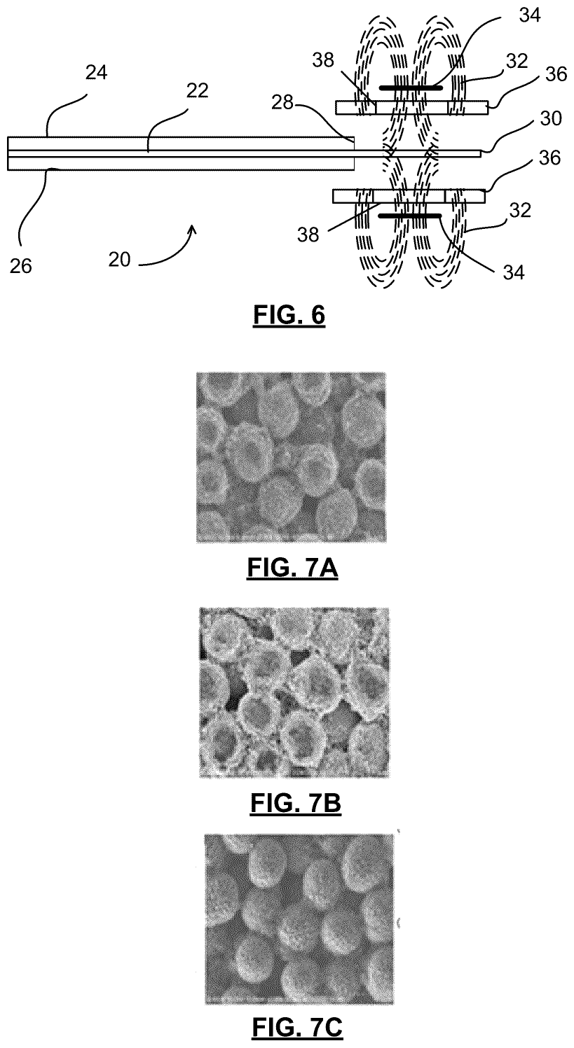

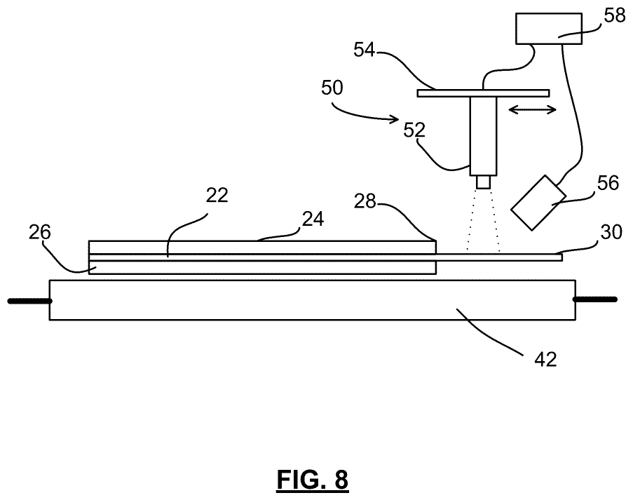

As shown in FIG. 6, the magnetic field 32 can be applied to both side of the exposed metal edge margin 30 with two opposed electromagnetic coils 34, each with its own shield 36 to control the quantity and location of the energy applied to the exposed metal edge margin.

Methods of this disclosure can be incorporated into a continuous manufacturing process in which the electrode strip 20 is supported on non-magnetic and non-magnetically permeable rollers 42 and transported past one or more electromagnetic coils 34 and the shields 36 (in the direction indicated by the arrow D in FIGS. 2 and 4), heating the exposed metal edge margin 30 in a continuous process. The rollers 42 support the strip 20 and help to maintain a fixed distance between the surface of the exposed metal edge margin 30 and the electromagnetic coils 34 and their respective shields 36.

This arrangement also allows for a fast change over to other electrode types, as the electromagnetic coil can be standardized to provide a sufficiently strong magnetic field to sufficiently heat all the types of electrodes being produced, and the adapted to the particular electrode being produced by simply changing the shield. For example, anode electrodes typically have a copper substrate, and cathode electrodes typically have an aluminum substrate. Copper has greater thermal conductivity than aluminum, so a different shield with a different aperture might be used on a copper electrode than on an aluminum electrode in order to achieve satisfactory heating of the exposed metal edge margin without adversely affecting the coating that have been applied to these substrates.

According to another embodiment of this disclosure, a system for annealing the exposed metal edge margins of an electrode is provided. As shown in FIGS. 3 and 6, this system comprises a source of variable magnetic field, such as electromagnetic coil 34, and a magnetic shield 36, having an aperture 38, disposed between the source of the magnetic field and the exposed metal edge margins of the electrode. The shield 36 and aperture 38 are preferably configured to apply magnetic field to exposed metal edge margins to heat a substantial portion of the exposed metal edge margin to an annealing temperature, while maintaining the temperature of the substrate adjacent the electrode material sufficiently low to minimize or avoid any deleterious temperature effects. The strip 20 can be passed by the magnetic field source and shield on rollers that support the strip and maintain the strip at a fixed distance from the shield and the magnetic field source.

According to another embodiment of this disclosure, indicated generally as 50 in FIG. 8, a laser 52 can be provided to heat and thus anneal the exposed metal edge margin 30 of the electrode strip 20. The laser 52 can be mounted on a translation or orientation system 54 so that the laser can be directed to a particular portion of the exposed metal edge margin. A thermal sensor, such as an infrared thermal sensor 56 can scan the exposed metal edge margin 30 to determine its temperature. A control 58 can be provided to control the position, power, and/or duration of application of the laser 52 in response to the temperature measured by sensor 56. In this way the electrode coatings 24 and 26 can be protected from damaging overheating. Such thermal measurements could be applied to the other embodiments of this disclosure, and parameters such as electromagnetic positioning, power and frequency, as well as shield position and opening size, and the travel speed of the strip, can be controlled to prevent the overheating of the electrode materials.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A method of annealing an exposed metal edge margin of a coated battery electrode strip to relieve stress and reduce wrinkling, the method comprising:
applying a magnetic field through an apertured magnetic shield to an exposed metal edge margin of a coated battery electrode strip to induce eddy currents in the exposed metal edge margin to heat the exposed metal edge margin to a desired annealing temperature, with the apertured magnetic shield blocking application of the magnetic field close enough to edge of the coating on the electrode strip to reach a temperature harmful to the coating.

2. The method according to claim 1 wherein the step of applying a magnetic field through an apertured magnetic shield to the exposed metal edge margin of the coated battery electrode strip comprises moving the exposed metal edge margin of a coated battery electrode strip through the magnetic field.

3. The method according to claim 1 wherein the step of applying a magnetic field through an apertured magnetic shield to the exposed metal edge margin of the coated battery electrode strip wherein the magnetic field is applied with an electromagnetic coil.

4. The method according to claim 3 wherein the step of applying a magnetic field through an apertured magnetic shield to the exposed metal edge margin of the coated battery electrode strip comprises moving the exposed metal edge margin of a coated battery electrode strip past the magnetic field.

5. The method according to claim 1 wherein the apertured magnetic shield comprises a plurality of layers of material.

6. The method according to claim 1 wherein the apertured magnetic shield comprises at least one of copper, silver, brass, titanium, tungsten, and lead.

7. The method according to claim 1 wherein the apertured magnetic shield comprises at least one of steel and stainless steel.

8. The method according to claim 1 wherein the apertured magnetic shield comprises at least one of ferromagnetic alloys, permalloy, or mu metal.

9. The method according to claim 1 wherein the apertured magnet shield comprises metal mesh.

10. The method according to claim 1 wherein the apertured magnetic shield comprises metal foam.

11. The method according to claim 1 wherein the apertured magnetic shield has an inboard side oriented toward the coating on the, and an outboard side oriented toward the edge of the exposed metal edge margin, and wherein the inboard side of the aperture has a straight edge extending parallel to the edge of the electrode coating.

12. The method according to claim 11 where the aperture widens toward the outboard side of the apertured magnetic shield.

13. The method according to claim 1 wherein the electrode strip moves in a direction parallel to the edge of the strip during the application of the magnetic field.

14. An apparatus for annealing an exposed metal edge margin of a coated battery electrode strip to relieve stress and reducing wrinkling, the apparatus comprising:
a source of magnetic field, and an apertured magnetic shield disposed between the source of the magnetic field and an exposed metal edge margin of a coated battery electrode strip that passes the magnetic field through the aperture to apply a magnetic field to the exposed metal edge margins of the coated battery electrode strip to induce eddy currents in the exposed metal edge margins to heat the exposed metal edge margins to a desired annealing temperature, and block application of a magnetic field close enough to the coating on the battery electrode strip to cause the coating it to reach a temperature harmful to the coating.

15. The apparatus for annealing an exposed metal edge margin of a coated battery electrode strip according to claim 14 wherein the source of the magnetic field is an electromagnetic coil.

16. The apparatus for annealing an exposed metal edge margin of a coated battery electrode strip according to claim 15 wherein the apertured magnetic shield comprises a plurality of layers of material.

17. The apparatus for annealing an exposed metal edge margin of a coated battery electrode strip according to claim 16 wherein the apertured magnetic shield comprises at least one of copper, silver, brass, titanium, tungsten, and lead.

18. The apparatus for annealing an exposed metal edge margin of a coated battery electrode strip according to claim 16 wherein the apertured magnetic shield has an inboard side oriented toward the coating on the strip battery electrode strip, and an outboard side oriented toward the edge of the exposed metal edge margin, and wherein the inboard side of the aperture has a straight edge extending parallel to the edge of the coating on the strip battery electrode strip.

19. The apparatus for annealing an exposed metal edge margin of a coated battery electrode strip according to claim 18 where the aperture in the magnetic shield widens toward the outboard side of the apertured magnetic shield.

20. A method of annealing an exposed metal edge margin of a coated battery electrode strip to relieve stress and reducing wrinkling, the method comprising: applying a laser to the exposed metal edge margin of the coated battery electrode strip at a location sufficient to heat the exposed metal edge margin to a desired annealing temperature, but spaced sufficiently from the edge of the coating on the electrode strip that the coating does not reach a temperature harmful to the coating.
